(19) United States
(12) Patent Application Publication
(10) Pub. No.: US 2003/0075141 A1
(43) Pub. Date: Apr. 24, 2003

(54) Piston for a direct-injection, spark-ignition engine and a direct-injection, spark-ignition engine equipped therewith

(75) Inventors: Noriyuki Ohta, Aki-gun (JP); Hiroyuki Yoshida, Aki-gun (JP); Hiroyuki Yamashita, Aki-gun (JP)

Correspondence Address: NIXON PEABODY, LLP, 8180 GREENSBORO DRIVE, SUITE 800, MCLEAN, VA, 22102, US

(73) Assignee: MAZDA MOTOR CORPORATION, Hiroshima (JP)

(21) Appl. No.: 10/254,016

(22) Filed: Sep. 25, 2002

(30) Foreign Application Priority Data
Sep. 28, 2001 (JP) 2001-303100

(51) Int. Cl. F02B 31/00

(52) U.S. Cl. 123/301; 123/305; 123/306; 123/307

(57) ABSTRACT

A piston structure for a direct-injection, spark-ignition engine which properly stratifies a mixture adjacent to the spark plug in a stratified-combustion operation without impairing the reliable ignition of the spark plug. In the direct-injection, spark-ignition engine, the central portion of the roof of the combustion chamber is located at a higher level than its peripheral portion, the spark plug is disposed in the central portion, the fuel injector is disposed on the left side of the central portion, and the fuel injector injects fuel so that the fuel contacts the tumble flow produced in the combustion chamber in such a manner that the mixture is concentrated adjacent to the spark plug and ignited in the area in which the tumble flow turns clockwise. On the piston, a cavity having the bottom surface along which the tumble flow flows and extending to both sides of the cylinder axis is formed, and a step provided on the left side of the cylinder axis on the bottom surface of the cavity for guiding the tumble flow upwardly in the area in which the tumble flow turns.

### FIELD OF THE INVENTION

This invention relates to a piston for an engine equipped with a fuel injector which directly injects fuel into a combustion chamber, and to a direct-injection spark-ignition engine equipped with the piston.

### DESCRIPTION OF THE RELATED ART

Conventionally, a direct-injection, spark-ignition engine has been known, which comprises a fuel injector directly injecting fuel into a combustion chamber, and controls the fuel injector to inject fuel during a compression stroke so as to concentrate a mixture adjacent to a spark plug and cause the stratified combustion with leaner air-fuel ratio of the stoichiometric air-fuel ratio in a condition of low engine-load and low engine-rotational speed, for improving fuel efficiency. Japanese Patent Publication No. H11-294307 discloses such a direct-injection, spark-ignition engine, in which fuel is conveyed to the proximity of the spark plug by a tumble flow after being injected into the combustion chamber from the fuel injector disposed on a peripheral wall of the combustion chamber, and the amount of the amount of the protrusion of the spark plug is adjusted according to an engine operational condition.

In accordance with the constitution described in the patent publication described above, the following advantages are attained. In a condition of high engine-load and high engine-rotational speed where the engine operates on the homogeneous-combustion mode with intake-stroke injection, the amount of the protrusion of the spark plug is reduced for large amounts of the injected fuel in the homogeneous-combustion mode. This prevents the wetting of the plug and incomplete ignitions due to the spark plug being directly exposed to the fuel spray, thereby stabilizing the homogeneous combustion for high engine-output and improved emission performance.

On the other hand, in low and middle engine-load and low and middle engine-rotational speed where the engine operates on the stratified-combustion mode with compression-stroke injection, the amount of the protrusion of the spark plug is increased. This ensures that the fuel is conveyed to the proximity of the spark plug, thereby improving engine-output and emission performance without any additional structure for causing the fuel spray to collide with the top surface of the piston.

In the constitution as above, which controls the protrusion of the spark plug according to the engine operational condition, however, a protruding mechanism for the spark plug is required at the upper portion of the combustion chamber. This complicates the engine structure and inevitably increases the engine size. Moreover, the increased amount of the spark-plug protrusion in the stratified-combustion mode inevitably causes the more amount of the fuel to deposit on an electrode in the form of droplets. This results in the spark plug repeatedly becoming cooled by the evaporation of the droplets and then heated by the ignition, which may prevent reliable ignition from the spark plug.

### SUMMARY OF THE INVENTION

In view of the problem above, an object of the present invention is to provide a simple piston structure for a direct-injection, spark-ignition engine which can properly stratify the mixture adjacent to the spark plug in the stratified-combustion operation, without impairing the reliable ignition of the spark plug.

In accordance with the present invention there is provided a piston for a direct-injection, spark-ignition engine in which the engine's intake system is configured so as to produce a tumble flow in a combustion chamber. A central portion of a roof of the combustion chamber is located at a higher level than its peripheral portion, a spark plug is disposed in the central portion, a fuel injector is disposed on the peripheral portion of the roof so as to inject fuel so that the injected fuel contacts the tumble flow produced in the combustion chamber in such a manner that the mixture is concentrated adjacent to the spark plug and ignited in the area in which the tumble flow turns clockwise. The piston is formed with a cavity having a bottom surface along which the tumble flow flows and which extends to both sides of the cylinder axis on the top surface of the piston; and a step provided on the fuel-injector side of the cylinder axis on the bottom surface of the cavity for guiding the tumble flow upwardly.

Accordingly, when the engine operates on the stratified combustion mode, the fuel spray injected by the fuel injector during the compression stroke and the tumble flow flowing along the cavity on the top surface of the piston contact each other. Thus, the fuel is promoted to atomize and mix with air, and then the mixture is moved upwardly so as to be concentrated adjacent to the spark plug.

Preferably, a shelf may be provided which continues from the upper edge of the step formed on the top surface of the piston, extends in parallel with the bottom surface of the cavity, and is located below the level of the opening ridge of the cavity.

Accordingly, when the engine operates on the stratified combustion mode, the fuel injected by the fuel injector during the compression stroke is prevented from depositing on the step and the shelf formed on the top surface of the piston, without impairing the guiding effect for the tumble flow by way of the step formed on the top surface of the piston.

Preferably, the top edge of the shelf may be located below the fuel-spray area when the piston is in place at the starting timing of the fuel injection in the stratified-combustion operation mode.

Accordingly, the fuel injected by the fuel injector during the compression stroke is reliably prevented from depositing on the top surface of the piston in the stratified combustion mode, without impairing the guiding effect for the tumble flow by way of the step formed on the top surface of the piston.

Preferably, the distance between an opening ridge on the opposite side to the fuel injector side of the cavity and the periphery of the piston is greater than the distance between an opening ridge on the fuel-injector side of the cavity and the periphery of the piston.

Accordingly, the tumble canter is effectively prevented from shifting during the copression stroke, and the weakening of the tumble flow is suppressed.

In accordance with the present invention, there is further provided a piston structure for a direct-injection, spark-ignition engine in which the engine's intake system is configured so as to produce a tumble flow in a combustion chamber. A central portion of a roof of the combustion chamber is located at a higher level than its peripheral portion, a spark plug is disposed in the central portion, a fuel injector is disposed on the fuel-injector side of the central portion so as to inject fuel so that the injected fuel contacts the tumble flow produced in the combustion chamber in such a manner that the mixture is concentrated adjacent to the spark plug and ignited. The piston is formed with a cavity along which the tumble flow flows on the top surface thereof, and the distance between an opening ridge on the opposite side to the fuel injector side of the cavity and the periphery of the piston is greater than the distance between an opening ridge on the fuel-injector side of the cavity and the periphery of the piston in the area in which the tumble flow occurs.

Accordingly, when the engine operates on the stratified combustion mode, the fuel spray injected by the fuel injector during the compression stroke and the tumble flow flowing along the cavity on the top surface of the piston confront against each other, so that the fuel is promoted to atomize and the mixture of the fuel and the air is properly stratified adjacent to the spark plug located at the canter of the combustion chamber. In addition, the tumble canter is effectively prevented from shifting during the compression stroke in the cross-section and the weakening of the tumble flow is suppressed, which maintains the strong tumble flow with its tumble-center near the central portion of the combustion chamber, as a result, the mixture is adequately stratified by the collision of the tumble flow and the fuel spray.

These and other objects, features, aspects, and advantages of the present invention will become more apparent from the following detailed description of the preferred embodiment relative to the accompanied drawings.

### BRIEF DESCRIPTION OF THE DRAWINGS

FIG. 1 is a schematic diagram showing a piston structure of a direct-injection, spark-ignition engine in accordance with the present invention;

FIG. 2 is a block diagram showing a detailed structure of a fuel delivery system.

FIGS. 3(a) and 3(b) are diagrams showing a cone angle of the fuel spray and the spray penetration;

FIG. 4 is a cross sectional view of the significant portion of a main body of the engine;

FIG. 5 is a cross-sectional view showing the detailed shape of the piston;

FIG. 6 is a plan view showing the detailed shape of the piston;

FIG. 7 is a plan view showing the aspect of the fuel injection;

FIG. 8 is a chart showing a control map showing the engine operational region;

FIGS. 9(a-f) are views graphically showing the change in the tumble flow in the comparison example;

FIGS. 10(a-f) are views graphically showing the change in the tumble flow in the embodiment of the present invention;

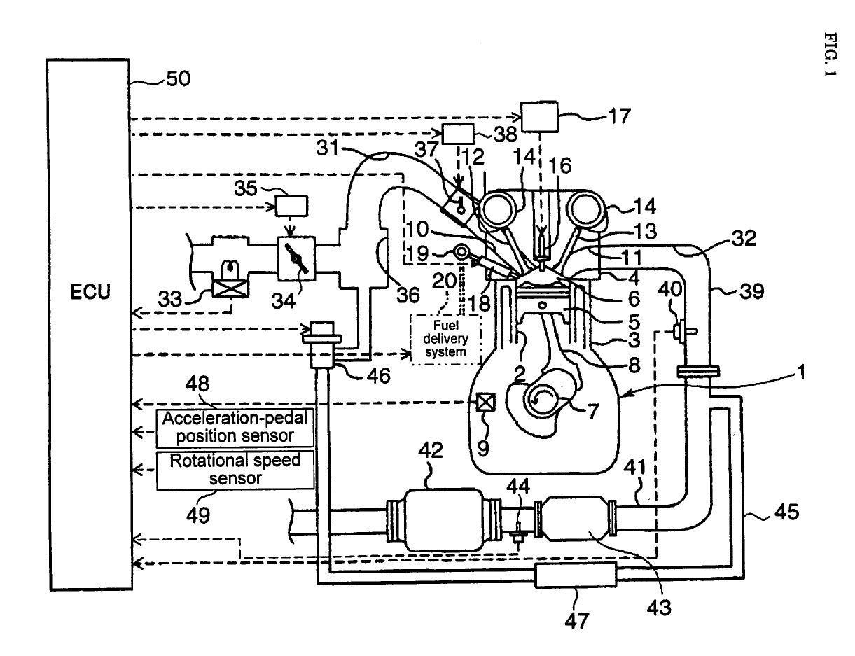

FIGS. 1(a-f) are views graphically showing the change in the mixture in the comparison example;

FIGS. 12(a-f) are views graphically showing the change in the mixture in the embodiment of the present invention;

FIG. 13 is a graph char showing the change in fuel efficiency with respect to the ignition timing;

FIG. 14 is a graph chart showing the change in combustion stability with respect to the ignition timing;

FIGS. 15(a-c) are views showing the change in the center of the tumble flow with respect to the position of the piston in the comparison example; and

FIGS. 16(a-c) are views showing the change in the center of the tumble flow with respect to the position of the piston in the embodiment of the present invention.

### DETAILED DESCRIPTION OF THE INVENTION

FIG. 1 illustrates an overall structure of a direct-injection, spark-ignition engine equipped with a piston in accordance with a preferred embodiment of the present invention. As illustrated in the drawing, a main body of the engine 1 includes a cylinder block 3 formed with a plurality of cylinders 2, a cylinder head 4 mounted on the cylinder block 3, a piston 5 fitted within each cylinder 2 so as to reciprocate in a vertical direction. The piston 5 is connected to a crankshaft 7 which is rotatably supported at the lower portion of the cylinder block 3 via a connecting rod 8. At an end of the crankshaft 7, an electromagnetic crank-angle sensor 9 is provided for detecting a crank angle (or a rotation angle of the crankshaft). A combustion chamber 6 is defined between the piston 5 and the cylinder head 4.

The combustion chamber 6 of each cylinder 2 is of a so-called bent-roof type, the roof of which includes a pair of slant faces that each extend from the central portion of the roof to the lower surface of the cylinder head 4. A pair of intake ports 10 and a pair of exhaust ports 11 open on the two slant surfaces of the roof of the combustion chamber 6, respectively (refer to FIG. 6). An intake valve 12 and an exhaust valve 13 are disposed at the opening edge of the respective ports 10 and 11, the intake valve 12 and the exhaust valve 13 opening and closing at a predetermined timing for corresponding cylinders 2. The intake valve 12 and the exhaust valve 13 are driven by a valve-driving mechanism 14 including a pair of camshafts 14 rotatably supported at the upper portion of the cylinder head 4.

At the central top portion of the combustion chamber 6, a spark plug 16 is fitted so as to be surrounded by the four valves of two intake valves 12 and two exhaust valves 13, a tip end of the spark plug 16 projecting into the combustion chamber 6. The spark plug 16 is electrically connected to an ignition circuit 17 which energizes the spark plug 16 at a predetermined timing for corresponding cylinders.

On a peripheral wall of the cylinder 6, a fuel injector 18 is disposed between the two intake ports 10, the fuel injector 18 injecting fuel into the combustion chamber 6 (refer to FIG. 7). The proximal end of the fuel injector 18 is connected to a fuel distribution pipe 19 which distributes high-pressure fuel delivered from a fuel delivery system 20 for each cylinder.

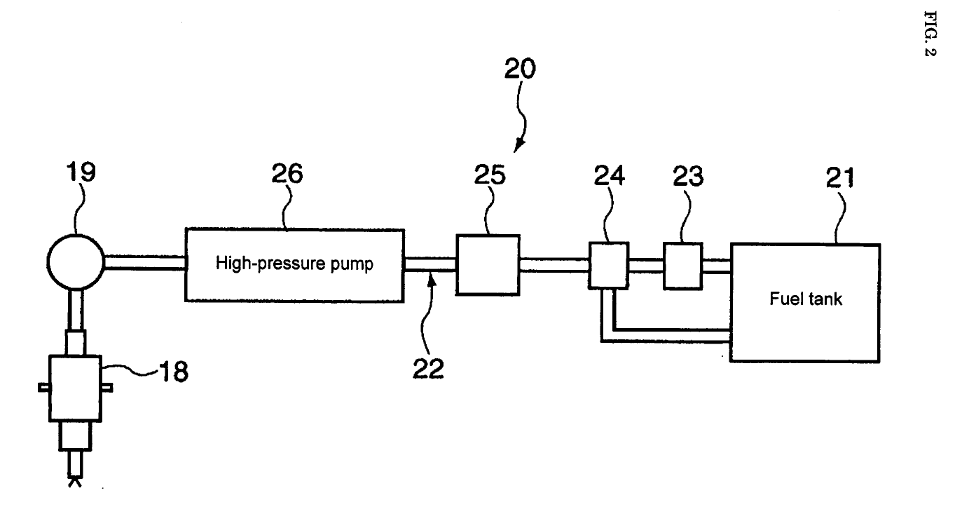

As shown in FIG. 2, the fuel delivery system 20 includes a fuel passage 22 which communicates the fuel distribution pipe 19 with a fuel tank 21. In the fuel passage 22, a low-pressure pump 23, a low-pressure regulator 24, a fuel filter 25 and a high-pressure pump 26 are disposed from the upstream side of the fuel passage 22. Fuel is sucked from the fuel 21 tank by the low-pressure pump 23, its pressure regulated by the low-pressure regulator 24, filtered through the fuel filter 25 and then fed into the high-pressure pump 26. The high-pressure pump 26 is an electromagnetic valve which can broadly adjust the amount of the discharged fuel. By adjusting the amount of the fuel discharged into the fuel distribution pipe 19, the pump 26 provides a desired spray pressure of the fuel (approximately ranging from 3 MPa to 13 MPa, preferably, 4 MPa to 7 MPa, for example). Alternatively, a high-pressure regulator may be provided, which partly returns fuel pressurized by the high-pressure pump 26 to the fuel tank 21 through a return passage for providing a desired pressure of the fuel discharged into the fuel distribution pipe 19.

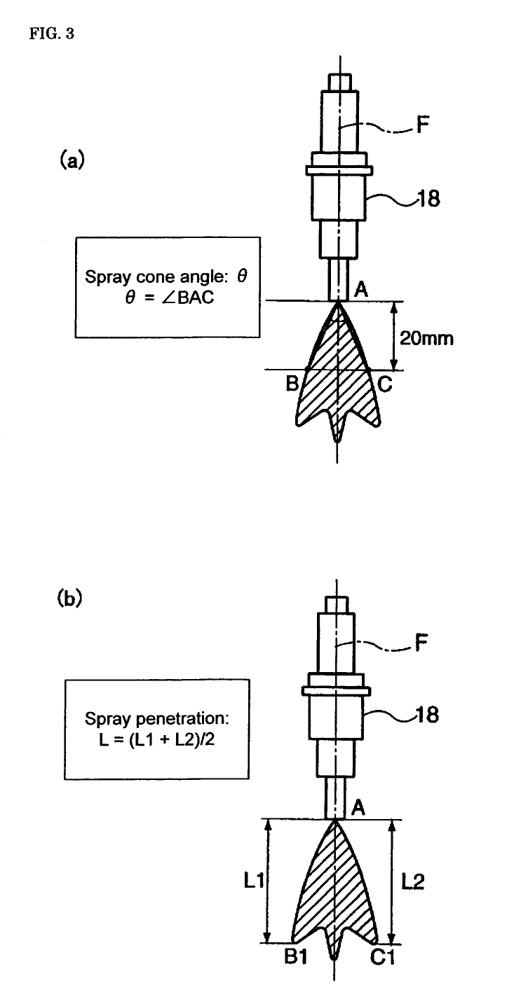

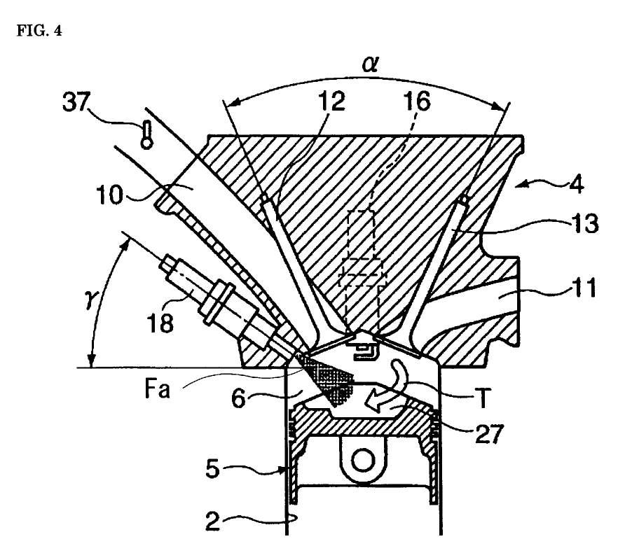

The fuel injector 18 includes an injection nozzle which injects a fuel spray with a spray cone angle equal to or less than 70°, for example 30°. The spray cone angle varies with the pressure condition in the combustion chamber 6. In this embodiment, however, two points B and C are determined at which assumed plane through the spray center line F and the profile of fuel spray interconnect with each other at a downstream portion from an injection bore A of the fuel injector by 20 mm, and ∠ BAC is defined as the spray cone angle θ, as illustrated in FIG. 3 (a).

Additionally, as illustrated in FIG. 3 (b), in the assumed plane including the spray center line F, the leading edges of the primary spray (or fuel droplet area) excluding a so-called premature spray (or initial spray) are defined as point B1 and point C1, respectively, the distance from the injection bore A of the fuel injector 18 to the point B1 along the fuel center line F and the distance from the injection bore A of the fuel injector 18 to the point C1 along the fuel center line F are defined as L1 and L2 respectively, then, the spray penetration is defined as an average of L1 and L2 (L=(L1+L2)/2).

For actually measuring the spray cone angle θ and the spray penetration L, a laser sheet method may be used, for example. Specifically, firstly, a sample of dry solvent, which is similar to actual fuel in property, is used as a fluid to be injected from the injector, and the pressure of the sample is set at a predetermined value (for example, 7 MPa) under normal temperature conditions. Further, the inside of a pressure vessel provided with a laser-transmittable window and a measuring window for filming spray is pressurized to 0.25 MPa for example, which is assigned to an ambient pressure. Then, under normal temperature conditions, the fuel is injected by inputting trigger pulse signals at a predetermined pulse width to the injector 18 so that the amount of spray per pulse is 9 mm³/stroke.

Thereafter, a 5 mm-thick laser light sheet is irradiated so as to pass the spray center line of the fuel spray, and spray images are photographed from a direction perpendicular to the laser light sheet plane by a high-speed camera. Then, the spray cone angle θ and penetration L of spray are determined in accordance with the definitions described above based on the image photographed 1.56 ms after the trigger pulse signal has been inputted. The spray profile in the photographed image refers to the profile of the area of particle samples in the form of droplet. The spray profile may be determined from the photographed image as a portion different in brightness because the laser sheet light illuminates the area of particle samples.

The structure of the main body of the engine 1 described above will now be described in further detail with reference to an enlarged cross-sectional view illustrated in FIG. 4. The intake port 10 extends straight and diagonally from the combustion chamber 6 and opens on one side surface of the main body of the engine 1 (or on the left-side surface thereof in FIG. 4). Two intake ports 10 (one of which is illustrated) are individually provided for a cylinder. The intake ports 10 are parts of a tumble generating means which causes the intake air introduced into the combustion chamber 6 through the intake port 10 to behave as a tumble flow T. As illustrated in FIG. 4, the tumble flow T turns clockwise (or in the direction indicated by an arrow in FIG. 4) in the cross-sectional view which depicts the intake port 10 on the left side and the exhaust port 11 on the right side in the combustion chamber 6.

The fuel injector 18 injects fuel in the direction opposite to the tumble flow T. That is, in the cross sectional view as illustrated in FIG. 4, the fuel injector 18, disposed on the left side in the combustion chamber 6, injects fuel in the rightward and downward direction, so that the injected fuel directs against the tumble flow T above the top surface of the piston 5.

The slant angle of the two slant faces constituting the roof of the combustion chamber 6 are so set that the angle between the axes of the intake valve 12 and the exhaust valve 13 (or valve included angle) α are relatively greater angle, for example equal to 35° or more. Such a great angle between the slant faces prevents the intake port 10 and exhaust port 11 from tightly bending, so as to reduce the flow resistance of the intake air and exhaust gas.

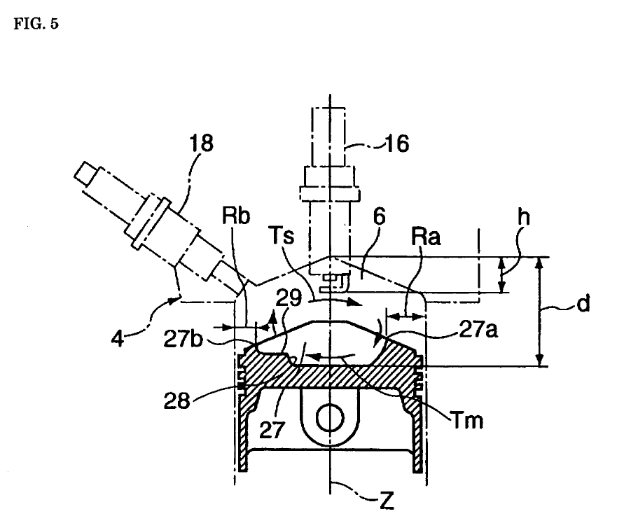

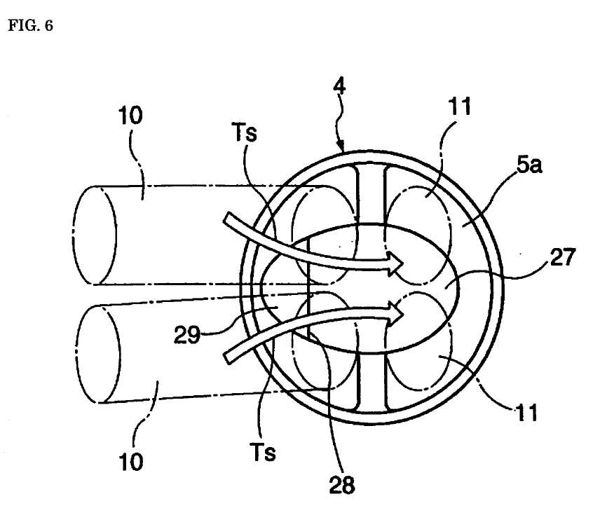

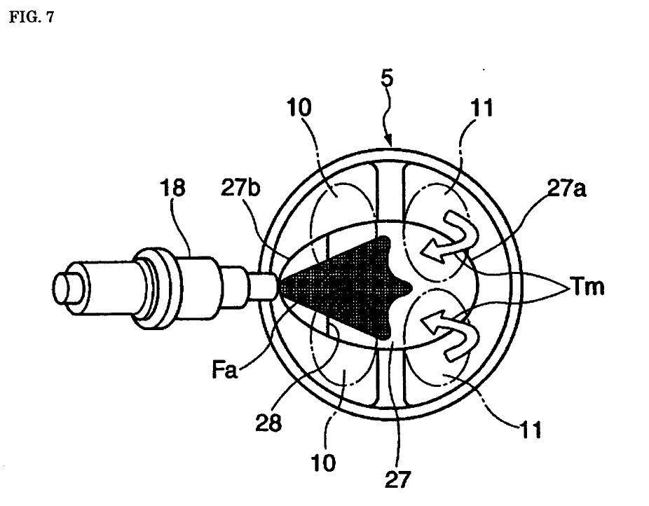

Here, a component flowing alongside of the roof of the combustion chamber 6 is defined as a first component Ts of the tumble, and a component flowing alongside of the bottom of the combustion chamber 6 is defined as a second component Tm of the tumble. As illustrated in the cross-sectional view of FIG. 5, the top surface of the piston 5 is formed with a cavity 27 extending to both sides of the cylinder axis Z and including an approximately horizontal bottom surface along which the second component Tm flows. On the left side of the cylinder axis Z in the cavity 27, a step 28 is provided on the bottom surface of the cavity 27 for directing the second component upwardly. The step 28 continues to a shelf 29 extending in parallel with the bottom surface of the cavity 27, or extending approximately horizontally. The shelf 29 is below the level of the opening ridge of the cavity 27, and is located below the level of mating surfaces of the cylinder block 3 and the cylinder head 4 at the top dead center of the compression stroke of the piston 5.

In addition, when the piston is in place at the starting timing of the fuel injection in the stratified-combustion operation mode, the top edge of the shelf 28 is located below the fuel-spray area. Moreover, when the distance h is defined as the height difference between the top of the roof of the combustion chamber 6 and the electrode at the lower end of the spark plug 16 disposed on the roof of the combustion chamber 6, and the distance d is defined as the height difference between the top of the roof of the combustion chamber 6 and the level of bottom surface of the cavity 27 in the piston 5 at the top dead center of the compression stroke, h is one half of d or less. Further, other dimensions such as the amount of the protrusion of the spark plug 16 and a tilt angle γ of the fuel injector 18 are so set that the electrode of the spark plug 16 is located above the fuel-spray area.

The cavity 27 formed on the top surface of the piston 5 is configured so that the distance Ra between the right opening ridge 27a and the periphery of the piston is greater than the distance Rb between the left opening ridge 27b and the periphery of the piston in the cross-sectional view of FIG. 4 and FIG. 5 (or in the cross-section in which the tumble flow T turns clockwise). Additionally, as shown in a plan view of FIG. 6 and FIG. 7, the opening ridge of the cavity 5a is generally oval in shape, with a major axis oriented along the direction of the fuel injection and with a minor axis perpendicular to the major axis. Further, the second component Tm and the fuel spray Fa are introduced into the cavity 27a from the opposite direction to each other, so that the tumble flow T and the fuel spray Fa confront each other within the cavity 27a.

A perimeter 5a outside of the cavity 27 on the top surface of the piston 5 has a profile in parallel with and corresponding to the slant faces of the roof of the combustion chamber 6, which the perimeter 5a confronts. A gap between a perimeter 5a of the top surface of the piston 5 and the roof of the combustion chamber 6 is squished by them during a term prior to a top-dead-center in the cylinder 2, for example a term from BTDC 40° CA to TDC. “TDC” and “BTDC” refer to “top dead center” and “before top dead center”, respectively, and “CA” refers to “crank angle”.

Referring again to FIG. 1, an intake-air passage 31 is connected to one side surface of the main body of the engine 1 and communicates with the intake port 10 for the corresponding cylinder 2. On the other hand, an exhaust-gas passage 32 is connected to the other side of the main body of the engine 1 and communicates with the exhaust port 11 for the corresponding cylinder 2.

The intake-air passage 31 delivers intake air filtered through an air cleaner (not illustrated) into the combustion chamber 6 of the corresponding cylinder 2 of the main body 1. From the upstream side of an airflow, an air-flow sensor 33 of hot-wire type for detecting the amount of intake air, an electric-controlled throttle valve 34 driven by an electric motor 35 to open and close, and a surge tank 36 are disposed in the intake-air passage 31. The downstream side of the surge tank 36 of the intake-air passage 31 branches out into individual intake-air passages for each cylinder 2. Each individual passage is further separated into two passages at its end to communicate with the two intake ports 10, respectively.

In an upstream portion of each of the two intake ports 10, a tumble control valve 37 is provided for adjusting the strength of the tumble flow in the combustion chamber 6. The tumble control valve 37 is operated to open and close by way of an actuator 38 such as a stepping motor. The tumble control valve 37 is of a disciform butterfly valve formed with a notch that is formed at a lower portion of a rotational axis of the valve. When the tumble control valve 37 is fully closed, intake air passes through the notch so as to generate a strong tumble flow in the combustion chamber 6. The tumble flow becomes weaker gradually as the tumble control valve 37 is opened.

Shapes of the intake port 10 and the tumble control valve 37 are not limited to ones described above. For example, the intake port 10 may be of a so-called common port type with one branch portion at which the passage is separated into respective ports. In this case, the tumble control valve 37 may be formed into a shape which corresponds to the cross-section of the common port and being partially notched.

On the other hand, the exhaust-gas passage 32 discharges combusted gas from the combustion chamber 6 to the outside. At the upstream end of the exhaust-gas passage 32, an exhaust-gas manifold 39 is provided which communicates with the corresponding exhaust port 11 for each cylinder 2. In a collecting portion of the exhaust-gas manifold 39, a linear O₂ sensor 40 is provided for detecting oxygen concentration of the exhaust gas and which generates a linear output for the oxygen concentration over the predetermined air/fuel ratio range including the stoichiometric air/fuel ratio. The oxygen concentration of the exhaust gas detected by the linear O₂ sensor 40 is used for determining the air/fuel ratio.

To the collecting portion of the exhaust-gas manifold 39, the upstream end of an exhaust-gas pipe 41 is connected. In the downstream portion of the exhaust-gas pipe 41, a NOx purification catalyst 42 and a three-way catalyst are provided for purifying the exhaust gas 43. Between both the catalysts 42 and 43 an exhaust-gas temperature sensor 44 is provided for detecting the temperature of the exhaust-gas. To the upstream portion of the exhaust-gas pipe 41, the upstream end of an EGR (or exhaust gas recirculation) passage 45 is connected which partially returns the exhaust-gas from the exhaust-gas passage 32 to the exhaust-gas passage 31. The downstream end of the EGR passage 45 is connected to the portion between the electric-controlled throttle valve 34 and the surge tank 36 of the intake-air passage 31. At the midstream portion of the EGR passage 45, an electric-controlled EGR valve 46 and an EGR cooler 47 are provided. The electric-controlled EGR valve 46 is driven to open and close for adjusting the amount of the returning exhaust gas, and the EGR cooler 47 cools the exhaust-gas.

The ignition circuit 17, the fuel injector 18, the fuel delivery system 20, an electric motor 35 for driving the electric-controlled throttle valve 34, the actuator 38 for driving the tumble control valve 37, and electric-controlled EGR valve 46 are each controlled by an engine control unit (referred to as ECU) 50. The ECU 50 receives electronic signals from the crank angle sensor 9, the air-flow sensor 33, the O₂ sensor 40, the exhaust-gas temperature sensor 44, an acceleration-pedal position sensor 48 for detecting the distance traveled by the acceleration pedal (or operation amount of the acceleration pedal), and a rotational speed sensor 49 for detecting the rotational speed of the engine.

Based upon the signals from the sensors, the ECU controls the amount of injected fuel, the injection timing, and the fuel spray pressure to be achieved by the fuel injector 18, the amount of the intake-air by adjusting the throttle valve 34, the strength of the tumble flow by adjusting the tumble control valve 37, and the amount of the returning exhaust-gas by adjusting the electric-controlled EGR valve 46 according to the engine-operational condition, respectively.

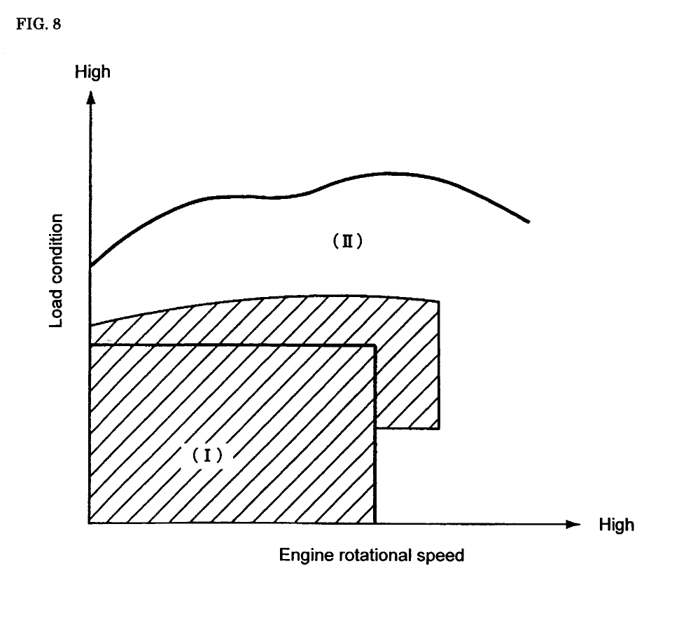

Particularly, as illustrated in FIG. 8 showing a control map in an engine warmed-up state, while the operational condition is inside of the rectangular region (I) of low engine load and low engine-rotational speed defined by bold lines, the engine operates on the stratified combustion mode, namely, the fuel injector 18 injects fuel within a period during the compression stroke of the cylinder 2 (within the period from 40° to 140° before the top dead center (BTDC), for example) so that the mixture concentrates adjacent to the spark plug 16 and combusts. In this stratified combustion mode, the throttle valve 34 is controlled to open relatively mode widely for providing leaner air-fuel ratio and for reducing intake loss. Particularly, at this time, the average air-fuel ratio is lean of the stoichiometric air-fuel ratio (A/F>25, for example) in the combustion chamber 6.

On the other hand, while the operational condition is in the region (II) outside of the stratified combustion region, the engine operates on the homogeneous combustion mode, namely, the fuel injector 18 injects fuel during the intake stroke of the cylinder 2 so that the fuel fully mixes with the intake air and the resulting homogeneous mixture in the combustion chamber 6 combusts. In this homogeneous combustion mode, the amount of the injected fuel and the opening of the throttle valve 34 are controlled so that the air-fuel ratio of the mixture is approximately stoichiometric air-fuel ratio (or A/F=14.7) in most part of the region. In the full-load condition, however, the air-fuel ratio is adjusted to rich of the stoichiometric air-fuel ratio (A/F=13, for example) to achieve high output in compliance with high load.

In the hatched region of FIG. 8 in the engine warmed-up state, the electric-controlled EGR valve 46 is opened for returning a part of the exhaust-gas from the exhaust-gas passage 45 to the intake-air passage 31. Then, the opening of the EGR valve 46 is controlled so that a ratio of the returning exhaust-gas (referred to as the EGR ratio) decreases at least for higher load, according to the engine load and the engine rotational-speed. This reduces the NOx production without impairing the combustion stability of the engine.

In an engine cold state, the engine operates on the homogeneous combustion mode, or the intermediate mode between the homogeneous combustion mode and the stratified combustion mode, and the electric-controlled EGR valve 46 is fully closed, for ensuring the combustion stability by the highest priority. The EGR ratio may be determined as the ratio of the amount of returning exhaust-gas from the EGR passage 45 to the intake-air passage 31 to the amount of the fresh air. Here, “fresh air” refers to the introduced air into the cylinder 2, from which of the returning exhaust-gas and the fuel gas are excluded.

In accordance with the direct-injection, spark-ignition engine in this embodiment described above, while the engine is operating on the stratified combustion mode, the average air-fuel ratio is lean of the stoichiometric air-fuel ratio in the combustion chamber 5 and the fuel injector 18 injects fuel at the late-stage of the compression stroke. Accordingly, the mixture is concentrated adjacent to the spark plug and ignited, providing the stratified combustion.

In this case, the air introduced through the intake-port 10 behaves as the tumble flow T in the combustion chamber 6 and stratifies the mixture adjacent to the spark plug 16. More particularly, as illustrated in the cross-sectional view of FIG. 4 and FIG. 5, the tumble flow T flows from the left (or intake-valve side) to the right (or exhaust-valve side) along the roof surface in the upper area of the combustion chamber 6, and turns downwardly in the right perpheral portion of the combustion chamber. The tumble flow T then flows from the right (or exhaust-valve side) to the left (or intake-valve side) along the cavity 27 on the top surface of the piston in the bottom area of the combustion chamber 6, turns upwardly guided by the step 28, and flows upwardly (or towards the roof surface) along the left peripheral portion of the combustion chamber.

The fuel injector 18 injects fuel so that the fuel contacts the second tumble component Tm flowing along the cavity 27 on the top surface of the piston. As a result, the fuel spray Fa and the second component Tm flows substantially towards each other, and collide with each other within the cavity 27. Then, the fuel is promoted to atomize, and the fuel spray Fa reduces its velocity after colliding with the second tumble component Tm and sufficiently mixes with air so that the mixture hovers near the center of the combustion chamber 6.

Thereafter, the mixture produced by the collision of the fuel spray Fa and the second component Tm is moved upwardly and concentrated adjacent to the spark plug 16 to be properly stratified around the spark plug 16. The upward movement of the mixture is achieved by the step 28 formed on the left side of the cylinder axis Z for turning the second tumble component Tm upwardly in the cross-sectional view where the tumble flow T turns clockwise.

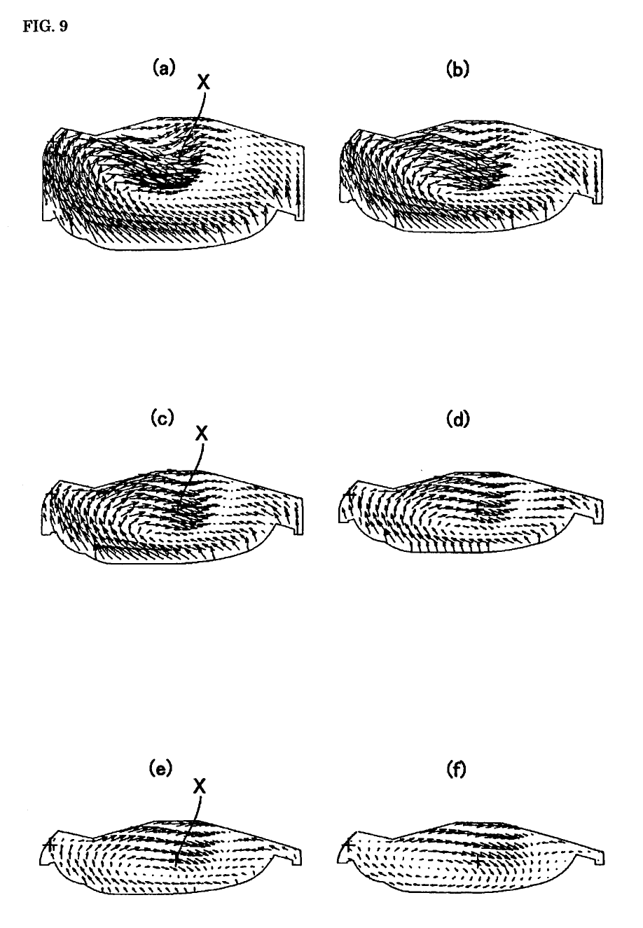

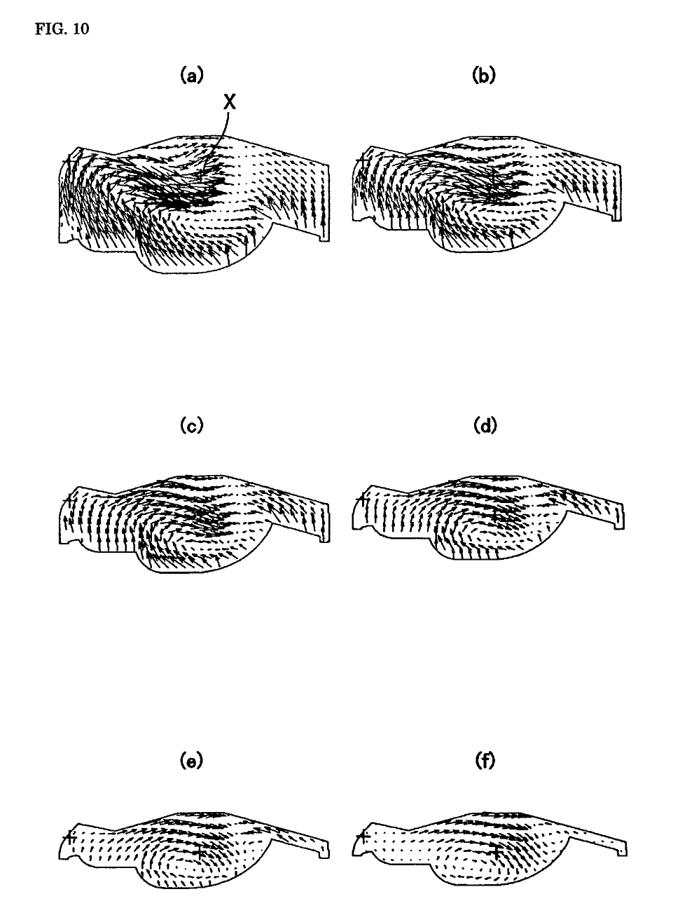

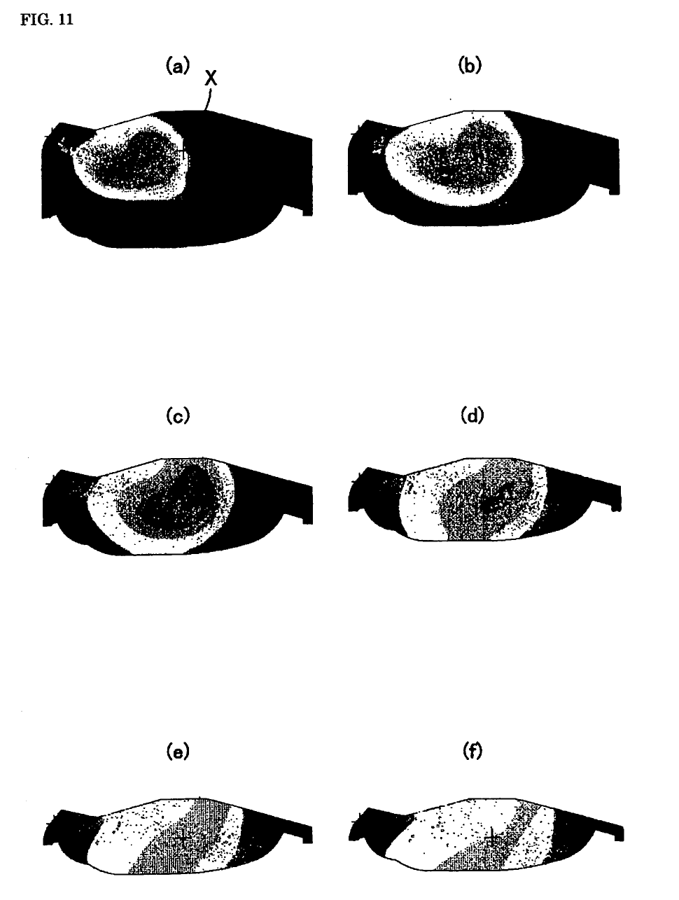

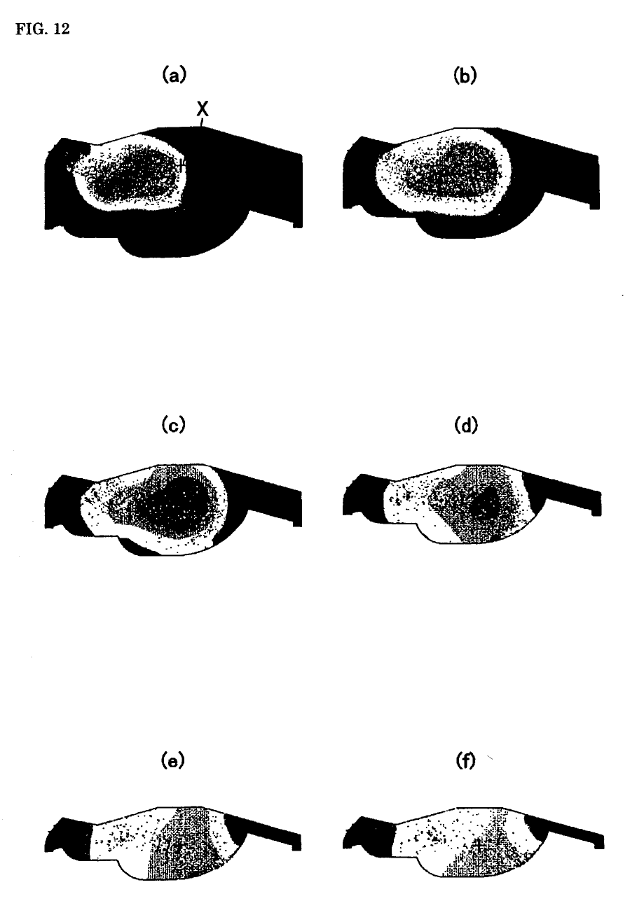

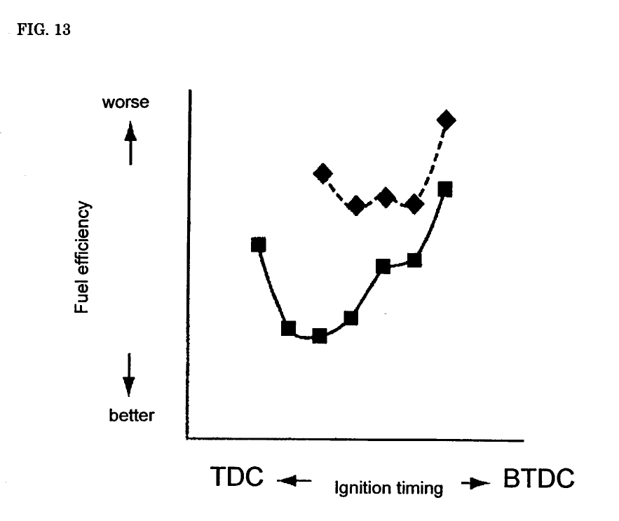

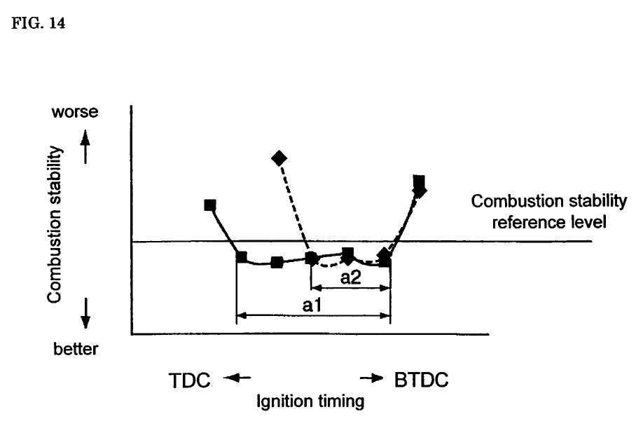

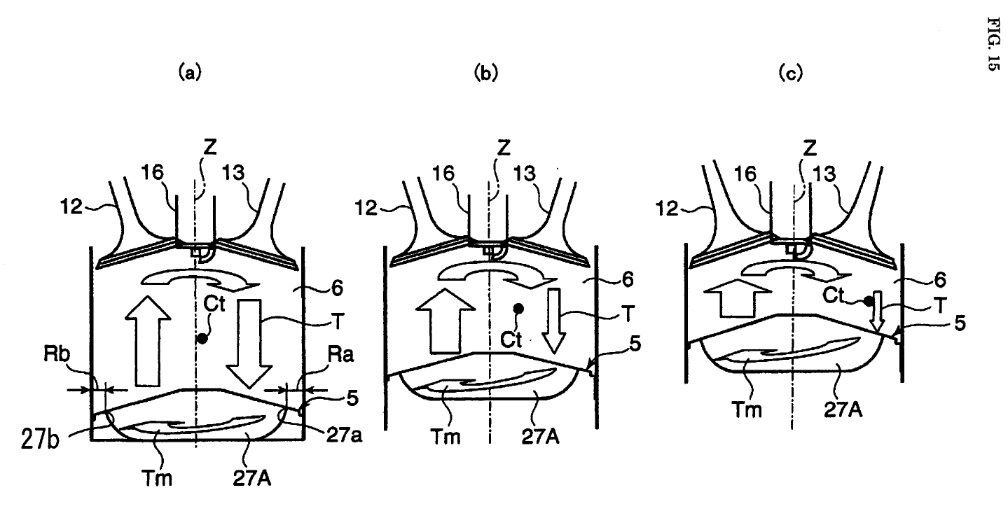

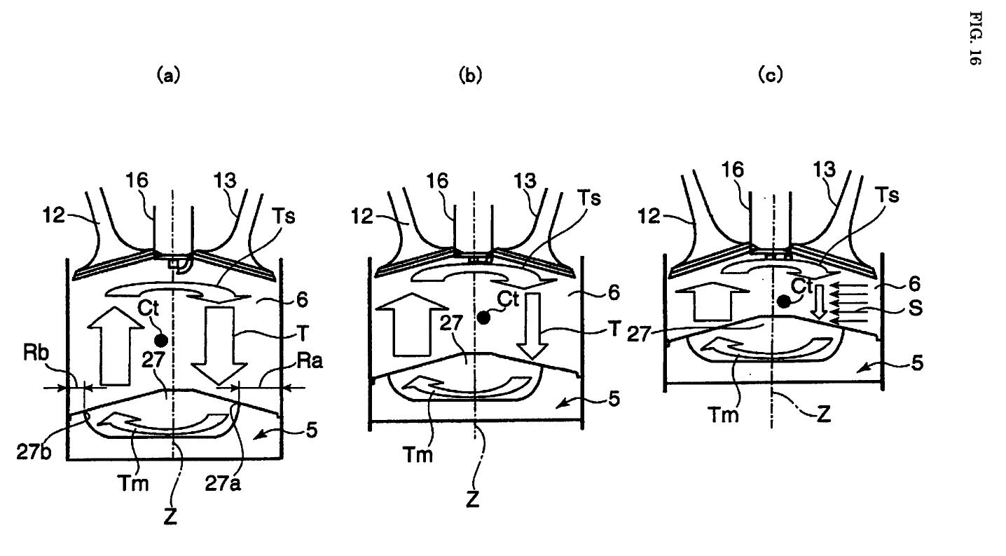

Illustrated in FIGS. 9 (a) to (f) and FIGS. 10 (a) to (f) are the data depicting the change in the tumble flow T from 310° to 360° CA after TDC, for a comparison example with only a cavity 27 over the top surface of the piston, and for the embodiment of the present invention with the step 28 on the top surface of the piston. The data were obtained by the analysis through CFD (or computational fluid dynamics). These data confirm that in the comparison example without the step 28, the tumble flow has a tendency of being widely diffused in the combustion chamber and disappearing as shown in FIGS. 9 (a) to (f), on the other hand, in the embodiment of the present invention with the step 28 on the top surface of the piston, the tumble flow remains turning around the electrode X of the spark plug 16 over a long period as shown in FIGS. 10 (a) to (f).

Additionally, illustrated in FIGS. 11 (a) to (f) and FIGS. 12 (a) to (f) are the data showing the change in the fuel spray under the influence of the tumble flow for the comparison example and for the embodiment of the present invention. These data confirm that in the comparison example without the step 28, the fuel spray diffuses early as shown in FIGS. 11 (a) to (f), on the other hand, in the embodiment of the present invention with the step 28 on the top surface of the piston, the relatively richer mixture remains in the vicinity of the electrode X of the spark plug 16 over a long period as shown in FIGS. 12 (a) to (f).

Accordingly, in a direct-injection, spark-ignition engine in which the fuel is injected so as to contact the tumble flow T produced in the combustion chamber 6 and the mixture is stratified in the vicinity of the spark plug 16 and ignited in the stratified combustion mode, the forming of the cavity 27 having the bottom surface along which the tumble flow T flows and extending to both sides of the cylinder axis Z on the top surface of the piston, and the forming of the step 28 on the left side of the cylinder axis Z on the bottom surface of the cavity 27 for guiding the tumble flow T upwardly in the cross-section in which the tumble flow T turns clockwise, beneficially maintain the adequate ignitionability of the mixture and improve fuel efficiency, without any structure for causing the fuel spray to collide with the top surface of the piston 5 in the stratified combustion mode with a tendency of low fuel spray pressure and the weak tumble flow.

That is, in the stratified combustion mode with low engine load and low engine rotational speed, the fuel spray pressure is reduced because of less amount of the fuel injection, and the strength of tumble flow represented by the tumble ratio is reduced because of less amount of the intake-air. Accordingly, the area of the mixture with sufficient fuel concentration for the spark plug to ignite is small and the mixture with such concentration tends to remain for a short period of time, even when the fuel spray Fa and the second tumble component Tm are arranged so as to flow towards each other and collide with each other in the cavity 27. Here, the tumble ratio is defined as a value obtained by the following calculation[:].

Firstly, measuring the velocity change in the vertical component of the intake-air flow in the cylinder 2 and integrating the measured value. Then, dividing the integrated value by the angular velocity of the crank shaft 7.

Conventionally, to cope with the above, the fuel injection is advanced before the timing for the best fuel efficiency, or the amount of the protrusion of the spark plug 16 is increased for maintaining the ignitionability in the stratified combustion mode. However, the fuel injection advance reduces fuel efficiency, and the increase in the protrusion of the spark plug impairs the reliability of the spark plug 16 because of the fuel droplets depositing on the electrodes.

In contrast, in the present invention, the cavity 27 having the bottom surface along which the tumble flow T flows and extending to both sides of the cylinder axis Z is formed on the top surface of the piston, and the step 28 is formed on the left side of the cylinder axis Z on the bottom surface of the cavity 27 for guiding the tumble flow T upwardly in the cross-section in which the tumble flow T turns clockwise, so that the mixture produced by the collision of the fuel spray Fa and the second component Tm is guided upwardly to concentrate in the vicinity of the spark plug 16. Accordingly, the mixture can be stratified in the vicinity of the spark plug properly over an extended time period without increasing the amount of the protrusion of the spark plug 16. As a result, the adequate ignitionability of the mixture is kept and fuel efficiency is improved without problems of impaired fuel efficiency due to the fuel injection advance or the depositing of the fuel droplets on the electrode of the spark plug 16 due to the increased amount of the protrusion of the spark plug 16.

To confirm the action and effect by the forming of the step 28 on the left side of the cylinder axis Z for guiding the tumble flow T upwardly, experiments were performed for revealing the difference in fuel efficiency and combustion stability between the comparison example with only a cavity 27 over the top surface of the piston and the embodiment of the present invention with the step 28 on the top surface of the piston. The results of the experiment are illustrated in FIG. 13 and FIG. 14.

FIG. 13 compares the change in fuel efficiency with respect to the crank angle (CA) for the ignition timing over the predetermined period of time before the top dead center (BTDC) between the comparison example and the embodiment of the present invention. In the figure, the broken line indicates the data of the comparison example and the solid line indicates the data of the embodiment of the present invention. These data confirm that the present invention can improve fuel efficiency over the comparison example by setting the ignition timing close to the timing for best fuel efficiency.

FIG. 14 compares the change in combustion stability with respect to the ignition timing between the comparison example and the embodiment of the present invention. In the figure, the broken line indicates the data of the comparison example and the solid line indicates the data of the embodiment of the present invention. These data confirm that in the present invention which properly achieves the stratified mixture in the vicinity of the spark plug 16, the time period for adequate combustion stability, or the allowable range of the ignition timing a1 within which the combustion stability exceeds the reference level is significantly wider than the allowable range for the ignition timing a2 of the comparison example.

In particular, in the case that the two slanted surfaces constituting the roof of the combustion chamber 6 are at relatively larger angle so that the angle between the axes of the intake valve 12 and the exhaust valve 13 (or valve included angle) θ is 35° or more for the purpose of reducing the bend of the intake port 10 and the exhaust port 11 to decrease the resistance of the intake air and the exhaust gas, the advantage by the constitution above is remarkably obtained, because the electrode of the spark plug 16 is disposed at the upper area of the combustion chamber 6 and the time period for the adequate combustion stability by the mixture layer properly formed adjacent to the electrode tends to shorten.

That is, in the present invention, the step 28 is formed on the left side of the cylinder axis Z on the bottom surface of the cavity 27 for guiding the tumble flow T upwardly in the cross-section described above so that the mixture produced by the collision of the fuel spray Fa and the second component Tm is guided upwardly. Accordingly, the present invention provides the remarkable advantage of effectively preventing the shortening of the time period for the adequate combustion stability, even with the electrode of the spark plug 16 disposed on the upper are of the combustion chamber 6.

In addition, in the embodiment described above, the shelf 29 is provided which continues from the upper edge of the step 28 formed on the top surface of the piston, extends in parallel with the bottom surface of the cavity 27, and is located below the level of the opening ridge of the cavity 27, in the cross-section in which the tumble flow T turns clockwise. Accordingly, in the stratified combustion mode, the fuel injected by the fuel injector 18 during the compression stroke is prevented from depositing on the step 28 and the shelf 29 formed on the top surface of the piston, without impairing the guiding effect for the tumble flow T by way of the step 28 formed on the top surface of the piston. As a result, the reductions in fuel efficiency and emission performance due to the fuel droplets depositing on the top surface of the piston are avoided without impairing the combustion stability.

Moreover, in the case that the top edge of the shelf 28 is located below the fuel-spray area when the piston is in place at the starting timing of the fuel injection in the stratified-combustion operation mode as described in the embodiment, the fuel injected by the fuel injector 18 during the compression stroke is effectively prevented from depositing on the top surface of the piston in the stratified combustion mode, without impairing the guiding effect for the tumble flow T by way of the step 28 formed on the top surface of the piston. As a result, the reductions in fuel efficiency and emission performance due to the fuel droplets depositing on the top surface of the piston are effectively avoided without impairing the combustion stability.

Further, in a direct-injection, spark-ignition engine in which the fuel is injected so as to contact the tumble flow T produced in the combustion chamber 6 and the mixture is stratified in the vicinity of the spark plug 16 and ignited in the stratified combustion mode, the setting of the distance Ra between the right opening ridge 27a of the cavity 27 on the top surface of the piston and the periphery of the piston to be greater than the distance Rb between the left opening ridge 27b and the periphery of the piston in the cross-section in which the tumble flow T turns clockwise can prevent the tumble center from shifting to the right during the compression stroke, which effectively suppress the weakening of the tumble flow T.

Particularly, in the comparison example as illustrated in FIG. 15 in which the distance Ra between the right opening ridge 27a of the cavity 27 on the top surface of the piston and the periphery of the piston is approximately equal to the distance Rb between the left opening ridge 27b and the periphery of the piston, the tumble center Ct is substantially on the cylinder axis Z at the early stage of the compression stroke during which the piston 5 is close to the bottom dead center. Then, the strength of the tumble flow T flowing downwardly at the right side of the axis and the strength of the tumble flow T flowing upwardly at the left side of the axis are approximately equal to each other as shown in FIG. 15(a). As the piston 5 ascends, the upward tumble flow T on the left side is strengthened by the piston 5, on the other hand, the downward tumble flow T on the right side is blocked by the upward airflow caused by the ascending piston 5 in the combustion chamber 6. As a result, the tumble center Ct gradually shifts to the right (or exhaust-valve side) as illustrated in the FIGS. 15 (b) and (c).

Additionally, in the comparison example, the tumble ratio increases from the bottom dead center until the middle stage of the compression stroke, but decreases after the middle stage of the compression stroke because the downward tumble flow T at the right area in the combustion chamber 6 is significantly weakened. Then, at the fuel injection timing, the tumble ratio is significantly reduced and the tumble flow T greatly decays.

On the other hand, in the present invention as illustrated in FIG. 16 in which the distance Ra between the right opening ridge 27a of the cavity 27 on the top surface of the piston and the periphery of the piston to be greater than the distance Rb between the left opening ridge 27b and the periphery of the piston in the cross-section above, the tumble center Ct is located on the left side of the cylinder axis Z at the early stage of the compression stroke during which the piston 5 is close to the bottom dead center as shown in FIG. 16 (a).

As the piston ascends, the tumble center Ct slightly shifts to the right. However, because the initial position of the tumble center is on the left side, the tumble center Ct does not greatly distant from the cylinder axis Z. Thereafter, as the piston reaches near the top dead center, a strong squish flow S is produced above the right portion of the piston. The squish flow S also prevents the tumble center Ct from shifting to the right (or exhaust-valve side), so that the tumble center Ct remains in the vicinity of the cylinder axis Z as shown in FIGS. 16 (b) and (c).

Moreover, in the present invention, the squish flow S strengthens the second tumble component Tm flowing along the bottom of the combustion chamber 6 after the middle stage of the compression stroke, so that the reduction in the tumble ratio is suppressed and the tumble flow T fully remains until the fuel injection timing. Then, because the tumble canter Ct remains near the center of the cylinder 6, the colliding location of the fuel spray and the tumble flow T is prevented from shifting to the peripheral side and the tumble flow T remains strong. In compliance to the tumble behavior, the required fuel-spray pressure is increased and the fuel injection is performed with the required pressure increased. Accordingly, the fuel spray and the tumble flow intensively collide with each other, which beneficially promotes the fuel to atomize and adequately concentrates the mixture adjacent to the spark plug.

In addition, the increase in the fuel spray pressure shortens the time period for injecting sufficient amount of the fuel, so that the injection timing can be retarded for the required amount of the fuel. This injection timing retard suppresses the diffusion of the fuel, which is advantageous to the stratification of the mixture.

It should be appreciated that the constitution in which the distance Ra between the right opening ridge 27a of the cavity 27 on the top surface of the piston and the periphery of the piston to be greater than the distance Rb between the left opening ridge 27b and the periphery of the piston in the cross-section above, and the constitution in which the step 28 is formed on the left side of the cylinder axis Z in the cavity 27 for guiding the tumble flow T upwardly as shown in FIG. 5, may be combined. This combination suppresses the weakening of the tumble flow T and maintains its tumble center close to the center of the combustion chamber, so as to adequately stratify the mixture as a result of the collision of the tumble flow T and the fuel spray.

As described above, in accordance with the present invention, there is provided the direct-injection, spark-ignition engine in which the intake system is configured so as to produce the tumble flow in the combustion chamber. The central portion of the roof of the combustion chamber is located at a higher level than its peripheral portion, the spark plug is disposed in the central portion, the fuel injector is disposed on the left side of the central portion, and the fuel injector injects fuel so that the fuel contacts the tumble flow produced in the combustion chamber in such a manner that the mixture is concentrated adjacent to the spark plug and ignited, in the cross-section in which the tumble flow turns clockwise. The cavity having the bottom surface along which the tumble flow flows and extending to both sides of the cylinder axis is formed on the top surface of the piston, and the step is formed on the left side of the cylinder axis on the bottom surface of the cavity for guiding the tumble flow upwardly, in the cross-section above. According to the constitution, a simple piston structure is attained for a direct-injection, spark-ignition engine which can properly stratify the mixture adjacent to the spark plug in the stratified-combustion operation, without impairing the reliable ignition of the spark plug.

As described above, in accordance with the present invention, there is also provided the direct-injection, spark-ignition engine in which the intake system is so configured to produce the tumble flow in the combustion chamber. The central portion of the roof of the combustion chamber is located at a higher level than its peripheral portion, the spark plug is disposed in the central portion, the fuel injector is disposed on the left side of the central portion, and the fuel injector injects fuel so that the fuel confronts against the tumble flow produced in the combustion chamber in such a manner that the mixture is concentrated adjacent to the spark plug and ignited, in the cross-section in which the tumble flow turns clockwise. The distance between the right opening ridge of the cavity on the top surface of the piston and the periphery of the piston is greater than the distance between the left opening ridge and the periphery of the piston in the cross-section above. According to the constitution, in the stratified combustion mode, the center of the tumble flow is effectively prevented from shifting to the right in the cross-section above and the weakening of the tumble flow is suppressed, so that the strong tumble flow with its tumble center close to the center of the combustion chamber remains until the fuel injection timing, thereby adequately stratifying the mixture as a result of the collision of the tumble flow and the fuel spray.

Although the present invention has been described in relation to particular embodiments thereof, many other variations and modifications and other uses will become apparent to those skilled in the art. It is preferred therefore, that the present invention be limited not by the specific disclosure herein, but only by the appended claims.

What is claimed is:

1. A piston for a direct-injection, spark-ignition engine including an intake system configured so as to produce a tumble flow in a combustion chamber, a central portion of a roof of the combustion chamber is located at a higher level than a peripheral portion thereof, a spark plug disposed in the central portion, a fuel injector disposed on the peripheral portion of the roof for injecting fuel that contacts the tumble flow produced in the combustion chamber in such a manner that the mixture is concentrated adjacent to the spark plug and ignited in an area in which the tumble flow, said piston comprising:
a piston body having a cavity with a bottom surface along an area in which the tumble flow flows, said cavity extending to both sides of a cylinder axis on the top surface of said piston body; and
a step provided on a fuel-injector side of the cylinder axis on the bottom surface of said cavity for guiding the tumble flow upwardly.

2. The piston for a direct-injection, spark-ignition engine as defined in claim 1, wherein a shelf is provided which continues from the upper edge of said step formed on the top surface of said piston body, said shelf extending in parallel with the bottom surface of said cavity and located below a level of the opening ridge of said cavity.

3. The piston for a direct-injection, spark-ignition engine as defined in claim 1, wherein the top edge of said shelf is located below a fuel-spray area when said piston body is in place at a starting timing of a fuel injection in a stratified-combustion operation mode of the direct-injection, spark-ignition engine.

4. The piston for a direct-injection, spark-ignition engine as defined in claim 1, wherein a distance between an opening ridge on the opposite side to the fuel-injector side of said cavity and the periphery of said piston body is greater than a distance between an opening ridge on the fuel-injector side of said cavity and the periphery of said piston body.

5. A piston for a direct-injection, spark-ignition engine including an intake system configured to produce a tumble flow in a combustion chamber, a central portion of a roof of the combustion chamber being located at a higher level than a peripheral portion thereof, a spark plug disposed in the central portion, a fuel injector disposed on the peripheral portion of the roof for injecting fuel that contacts the tumble flow produced in the combustion chamber in such a manner that a mixture is concentrated adjacent to the spark plug and ignited, said piston comprising:
a piston body formed with a cavity along an area in which the tumble flow flows on the top surface thereof, and a distance between an opening ridge on the opposite side to the fuel-injector side of said cavity and the periphery of said piston body is greater than a distance between an opening ridge on the fuel-injector side of said cavity and the periphery of said piston body in the area in which the tumble flow flows.

6. A direct-injection, spark-ignition engine equipped with a piston as defined in claim 1.

7. A direct-injection, spark-ignition engine equipped with a piston as defined in claim 5.
